(19) United States
(12) Patent Application Publication
(10) Pub. No.: US 2004/0048160 A1
(43) Pub. Date: Mar. 11, 2004

(54) Non-aqueous electrode battery

(75) Inventor: Atsuo Omaru, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/660,807

(22) Filed: Sep. 11, 2003

(30) Foreign Application Priority Data
Sep. 11, 2002 (JP) P2002-265952

(51) Int. Cl. H01M 4/58; H01M 4/66; H01M 4/40

(52) U.S. Cl. 429/231.4; 429/231.95; 429/234; 429/245; 429/94

(57) ABSTRACT

Disclosed is a battery which is improved in cyclic characteristics at the same time as the battery capacity is increased. On an anode substrate 8, there is formed, by a thin film forming technique, a layer of the active material 10, containing a metal that may be alloyed with lithium as an anode active material. The battery includes an anode 5 containing one or more of a metal not alloyed with lithium, an alloy or a compound containing the metal, and a carbonaceous material capable of doping/undoping lithium ions, as well as the metal that may be alloyed with lithium, a cathode 6 and a non-aqueous liquid electrolyte 4. The metal contained in the anode 5 as an anode active material and which may be alloyed with lithium acts to raise the battery capacity, while the metal not alloyed with lithium, alloys or compounds of this metal or the carbonaceous material suppresses deterioration of the anode 5 attendant on the charging/discharging to improve cyclic characteristics.

### BACKGROUND OF THE INVENTION

1. Field of the Invention

This invention relates to a non-aqueous electrode battery having a cathode and an anode having a thin film layer and exhibiting appreciably improved battery characteristics.

This application claims the priority of the Japanese Patent Application No. 2002-265952 filed on Sep. 11, 2002, the entirety of which is incorporated by reference herein.

2. Description of Related Art

Recently, development in a lightweight secondary battery with a high energy density, as a power supply for electronic equipment such as a notebook personal computer, a portable telephone set and a VTR (video tape recorder) with a built-in camera, is progressing. Among the secondary batteries having the high energy density, there is a lithium secondary battery having an energy density larger than that of the aqueous electrolyte battery, exemplified by a lead battery, a nickel-cadmium battery or a nickel-hydrogen battery.

With the lithium secondary batteries, such inconveniences may arise that lithium tends to be precipitated on the anode during charging, while lithium precipitated by repetition of charging/discharging tends to grow in size in the form of dendrites, with the precipitated lithium being inactivated to lower the battery capacity.

Such a lithium ion secondary battery in which a carbonaceous material is used as an anode, is known as a secondary battery designed to overcome the problem. Specifically, the lithium ion secondary battery uses an anode obtained on compacting the carbonaceous material in a finely divided state along with a binder.

This lithium ion secondary battery exploits, as a battery reaction, such a reaction consisting in intercalating lithium between layers of a carbonaceous material used for an anode, such as graphite. For this reason, with the lithium ion secondary battery, a carbonaceous material, capable of doping/undoping lithium, is used as the anode active material. This prohibits lithium from becoming precipitated to the anode of the lithium ion secondary battery at the time of charging to achieve superior battery characteristics. With this lithium ion secondary battery, the carbonaceous material used for the anode is also stable in air, thus improving the yield in manufacturing the batteries.

However, with the aforementioned lithium ion secondary batteries, it is difficult to increase the capacity further because there is a limitation to the capacity of the carbonaceous material used as the anode active material.

As a secondary battery for overcoming this problem, there is a lithium ion secondary battery which uses certain types of lithium alloys, capable of increasing the battery capacity, as the anode active material, in place of the carbonaceous material, and which effects charging/discharging by exploiting the reaction of electrochemically reversibly yielding or decomposing lithium. As for using lithium alloys for the anode active material, in the lithium ion secondary battery, it has already been known to use e.g. Li—Al alloys or Li—Si alloys as the anode active material.

Meanwhile, in the lithium ion secondary battery employing lithium alloys in the anode, lithium alloy particles sometimes undergo marked expansion and contraction attendant on charging/discharging, such that the lithium alloy particles may be cracked due to repetition of expansion and contraction of lithium alloys as a result of repetition of charging/discharging. Specifically, when the lithium alloys are expanded, neighboring lithium alloy particles thrust one another on expansion of lithium alloys caused by charging, thus producing cracks in the particles. Since the thrusting of the lithium alloy particles against one another is repeated by the repetition of charging/discharging cycles, the cracks produced in the particles grow in size until the lithium alloy particles are ultimately cracked.

Thus, with the lithium ion secondary battery, contact in the active material of the anode is sometimes broken as a result of cracking of the lithium alloy particles, with the result that the electrical conductivity of the anode is lowered to deteriorate battery characteristics.

As means for improving the inconvenience, it is proposed in, for example, the Extended Abstract to the 42nd Meeting on Lectures and Discussions on the Battery (No.2 B13) to use an anode in the form of a thin film of a lithium alloy to improve battery characteristics.

However, in this proposal, it is difficult to overcome the deterioration caused by repetition of the charging/discharging of the anode employing lithium alloys as the anode active material, such that the characteristics of the anode active material expected to help increase the battery capacity cannot be exploited sufficiently.

### SUMMARY OF THE INVENTION

It is therefore an object of the present invention to overcome the aforementioned problems of the related art and to provide a non-aqueous electrode battery of large battery capacity and in which it is possible to suppress deterioration of battery characteristics caused by repetition of charging/discharging.

The present invention provides a non-aqueous electrode battery comprising a cathode containing an cathode active material, an anode including one or more thin film layer(s) containing a first metal that may be alloyed with lithium, as an anode active material, and a non-aqueous electrolyte containing an electrolyte salt. The thin film layer(s) is formed by a thin film forming technique. The anode contains one or more of a second metal not alloyed with lithium, a third metal that may be alloyed with said second metal, a fourth metal not alloyed with said second metal, and a carbonaceous material capable of doping/undoping lithium ions.

With the non-aqueous electrode battery, in which the thin film layer contains a first metal that may be alloyed with lithium, the battery capacity may be made higher than that of the conventional non-aqueous electrode battery in which only the carbonaceous material is used as the anode active material.

Moreover, with the non-aqueous electrode battery, in which the first metal as the anode active material is provided as a thin film on the anode substrate, it is possible to suppress cracking of the first metal that may be produced due to expansion and contraction of the first metal caused by charging/discharging.

Additionally, the metals and/or the carbonaceous material other than the first metal scarcely undergo expansion or contraction due to charging/discharging and thus prove a cushioning material for moderating the expansion or contraction of the first metal attendant on charging/discharging. As a consequence, it is possible to prevent the neighboring particles of the first metal expanded on charging from thrusting against one another to cause cracks. Thus, with the non-aqueous electrode battery, it is possible to suppress cracking of the first metal or chipping of the thin film layer otherwise caused by repetition of expansion and contraction of the first metal attendant on the repetition of the charging/discharging cycles.

With the non-aqueous electrode battery of the present invention, the anode of which includes a thin film layer containing the first metal that may be alloyed with lithium, it is possible to raise the battery capacity.

Moreover, with the non-aqueous electrode battery of the present invention, in which the anode is provided with a thin film of the first metal formed by the thin film forming technique, it is possible to suppress the cracking of the particles of the first metal due to charging/discharging.

Additionally, with the non-aqueous electrode battery of the present invention, in which the anode contains one of the second metal not alloyed with lithium, the third metal that may be alloyed with the second metal, the fourth metal not alloyed with the second metal and the carbonaceous material capable of doping/undoping lithium ions, as well as the first metal, it is possible to suppress cracking of the particles of the first metal due to expansion and contraction brought about by charging/discharging to thereby suppress the lowering of the battery characteristics attendant on the repetition of charging/discharging.

Thus, the present invention provides a non-aqueous electrode battery which is superior in cyclic characteristics at the same time as it is increased in the battery capacity.

### BRIEF DESCRIPTION OF THE DRAWINGS

FIG. 1 is a cross-sectional view showing an inner structure of a lithium ion secondary battery embodying the present invention.

### DESCRIPTION OF THE PREFERRED EMBODIMENTS

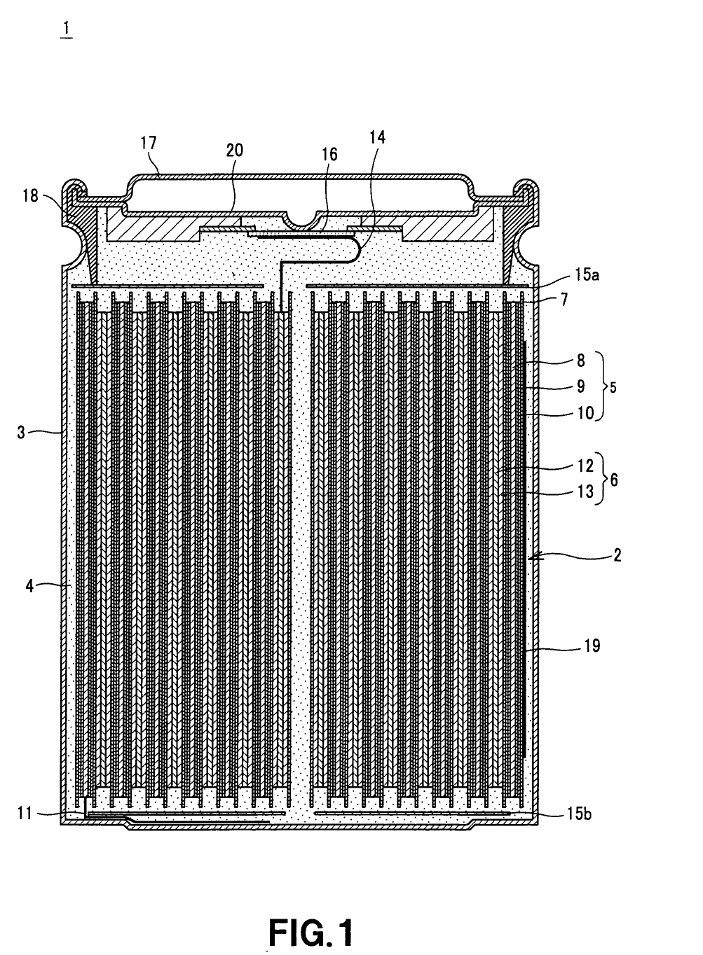

Referring to FIG. 1, showing a cylindrically-shaped lithium ion secondary battery 1, sometimes referred to below as battery 1, a battery according to the present invention will be explained in detail. This battery 1 is a non-aqueous electrolyte battery and is of such a structure in which a battery element 2 as a power generating element is sealed along with a non-aqueous liquid electrolyte 4 in an outer can 3.

The battery element 2 is of such a structure in which a band-shaped anode 5 and a band-shaped cathode 6 are coiled together with a band-shaped separator 7 in-between.

The anode 5 includes an anode substrate 8 on which a current collecting layer 9 exhibiting electron conductivity and a layer of an active material 10 containing an anode active material are formed in this order. An anode terminal 11 is connected to a preset location of the anode substrate 8 of the anode 5 so as to be protruded from one end along the width-wise direction of the anode substrate 8 in the state the anode terminal 11 is contacted with the current collecting layer 9. A strip-shaped metal piece, formed of an electrically conductive metal, such as copper or nickel, is used as the anode terminal 11.

For the anode substrate 8 of the anode 5, a metal foil or a polymer film, for example, is used. Specifically, a metal foil formed of an electrically conductive metal, such as copper, nickel, titanium or iron, may be used as the metal foil used as the anode substrate 8.

When the metal foil is used as the anode substrate 8, the metal foil is preferably of a thickness not larger than 10 μm and is on the order of 5 μm. If the thickness of the metal foil is thicker than 10 μm, the energy density of the battery 1 is decreased because of the heavy true specific gravity of the battery 1. If conversely the thickness of the metal foil is too thin, e.g. the tensile strength of the metal foil is lowered to deteriorate the manufacture yield of the battery 1.

When the polymer film is used as the anode substrate 8, the energy density of the battery 1 may be improved because of the lighter true specific gravity of the polymer film as compared to the metal foil. The manufacture yield of the battery 1 may be improved because the tensile strength of the anode substrate may be made higher than that of the metal foil depending on the type of the polymer used.

In the anode substrate 8, the material of the polymer film may be exemplified by an olefinic resin, a sulfur-containing resin, a nitrogen-containing resin, and a fluorine-containing resin. One of these resins or a compound of a plural number of these resins is used. Specifically, a film exemplified by polyethylene, polypropylene, polyvinylidene fluoride, polytetrafluoroethylene, nylon, polyphenylene sulfide, polyester, cellulose triacetate, Mylar, polycarbonate, polyimide, polyamide, and polyamideimide, may be used.

In the polymer film, the content of the element(s) having an atomic number larger than that of carbon is suppressed, to improve the energy density. Specifically, the true specific gravity of the polymer film is desirably not less than 0.9 g/cc and not larger than 1.8 g/cc and more desirably not less than 0.93 g/cc and not larger than 1.4 g/cc. If the true specific gravity of the polymer film is outside the above-defined range, it becomes difficult to realize the desirable performance with respect to, for example, the tensile strength, tensile elasticity or thermal conductivity.

Moreover, in the polymer film, the tensile strength (ASTM: D638) for improving the manufacture yield of the battery 1 is preferably not less than 0.9 kgf/mm², more preferably 2 kgf/mm² and most preferably 3 kgf/mm². In the polymer film, the tensile elasticity (ASTM: D790) for suppressing the effect by expansion or contraction attendant on charging/discharging of the layer of the active material 10 formed on the anode substrate 8 is preferably not less than 20 kgf/mm², more preferably 70 kgf/mm² and most preferably 100 kgf/mm². The polymer having such tensile strength and tensile elasticity may be exemplified by for example high density polyethylene, ultra-high molecular weight polyethylene, polypropylene, nylon, polyphenylene sulfide, polyester, cellulose triacetate, Mylar, polycarbonate and polyimide.

The polymer film is desirably of high thermal conductivity in order to properly release heat evolved on charging/discharging the battery 1 to outside. Specifically, the thermal conductivity (ASTM: C177) of the polymer film is desirably not less than 3×10⁴ cal/cm².sec.(K.cm⁻¹)⁻¹. Examples of the polymers having this thermal conductivity include low density polyethylene, high density polyethylene, ultra-high molecular weight polyethylene, polypropylene, nylon, polyphenylene sulfide, polyester, cellulose triacetate, Mylar and polycarbonate.

In the anode 5, the current collecting layer 9, formed on the anode substrate 8, acts for causing the current to flow in the layer of the active material 10 to increase the electrical conductivity. Thus, any relatively lightweight metals, exhibiting satisfactory electron conductivity, may be used for producing the current collecting layer 9. Examples of the metals that may be used include titanium, stainless steel, iron and aluminum. Meanwhile, if aluminum is used for the current collecting layer 9, the favorable effect on electron conduction may be expected to the utmost extent, however, it is necessary to coat aluminum with a metal not alloyed with lithium, in order to prevent aluminum from being exposed to outside.

The current collecting layer 9 is formed by a thin film forming technique, such as vapor deposition, sputtering, electroplating or electroless plating, to a thickness on the order of several lam. If a polymer film is used for the anode substrate 8, it is necessary to form the current collecting layer 9 because the polymer film has no electric conductivity. On the other hand, if an electronic conductive metal foil is used for the anode substrate 8, the anode substrate 8 may perform the role of the current collecting layer 9, because the anode substrate 8 is electrically conductive.

The layer of the active material 10 is formed of, for example, metals not alloyed with lithium or compounds including the metals, as anode active material, by a thin film forming technique, such as vapor deposition, sputtering, electroplating or electroless plating, to a thickness on the order of several μm, as the above-described current collecting layer 9.

The anode active material contained in the layer of the active material 10 include compounds represented by the chemical formula MₓM′_{y}Li_{z}, where M is a metal element that can be alloyed with lithium, M′ is a metal element other than the element Li and the element M, x is a numerical value larger than 0 and y, z are numerical values not less than 0. In these compounds, represented by the above chemical formula, B, Si or As, as semiconductor elements, may also be used as metal elements that can be alloyed with lithium. Specifically, metal elements, such as Mg, B, Al, Ga, In, Si, Ge, Sn, Pb, Sb, Bi, Cd, Ag, Zn, Hf, Zr, Y or As, compounds containing these metal elements, Li—Al, Li—Al—M, where M is one or more of transition metal elements of the 2A, 3B and 4B groups, AlSb or CuMgSb, for example, are used as an anode active material.

In particular, as the metal elements that can be alloyed with lithium, typical elements of the 3B group are desirable. Of these elements, Si or Sn, especially Si, is desirable. Specifically, Si and Sn compounds represented by the chemical formulas of MₓSi and MₓSn, where M is one or more element other than Si or Sn and x is a numerical value not less than 0, for example, SiB₄, SiB₆, Mg₂Si, Mg₂Sn, Ni₂Si, TiSi₂, MoSi₂, NiSi₂, CaSi₂, CrSi₂, Cu₅Si, FeSi₂, MnSi₂, NbSi₂, TaSi₂, VSi₂, WSi₂ or ZnSi₂, may be used either singly or in combination.

The layer of the active material 10 may contain metals not alloyed with lithium, such as Co, Cu, Fe, Mn, Mo, Nb, Ti, V, Cr or W, alloys or compounds containing these elements, in addition to the above-mentioned metal elements that may be alloyed with lithium. In order for the metals not alloyed with lithium or compounds thereof to be contained in the layer of the active material 10, the aforementioned thin film forming technique may be used. The metals not alloyed with lithium may form an intermetallic compound with the metal alloyed with lithium by, for example, applying heat treatment at a predetermined temperature after the metals not alloyed with lithium are contained in the layer of the active material 10.

It is possible for the carbonaceous material capable of doping/undoping lithium ions, such as graphitizable carbon, graphite or non-graphitizable carbon, to be contained in the layer of the active material 10. In order for the carbonaceous material to be contained in the layer of the active material 10, carbon by CVD (chemical vapor deposition) or sputtered carbon may be contained by the aforementioned thin film forming technique.

The non-graphitizable carbon, among the carbonaceous materials, may be exemplified by a monopolymer or a copolymer of furfuryl alcohol or furfural, or a furane resin, copolymerized with other resins and which is then sintered and carbonized. The non-graphitizable carbon is also of such physical parameters that the (002) spacing is not less than 0.37 nm, the true density is less than 1.70 g/cm³ and no peak of heat evolution is exhibited at 700° C. or higher in the differential thermal analysis (DTA) in air. The non-graphitizable carbon, having the above physical parameters, represents an anode active material having a large capacity.

For producing this non-graphitizable carbon, conjugated resins such as phenol resin, acrylic resin, halogenated vinyl resin, polyimide resin, polyamideimide resin, polyamide resin, polyacetylene or poly(p-phenylene), cellulose, cellulose derivatives or optional organic high molecular weight compounds may be used.

In addition, the petroleum pitch, having a specified H/C atomic ratio and into which an oxygen-containing functional group is introduced for oxygen cross-linking, proves an ultimate non-graphitizable carbon in the solid phase state, without becoming melted in the course of graphization carried out at a temperature exceeding 400° C.

It should be noted that the petroleum pitch is produced by such operations as distillation, e.g. vacuum distillation, atmospheric distillation or steam distillation, thermal polycondensation, extraction or chemical polycondensation, from asphalt or tars obtained on high-temperature thermal cracking of coal tar, ethylene bottom oils or crude oil. At this time, the H/C atom ratio of the petroleum pitch is crucial. For producing the non-graphitizable carbon, this H/C atom ratio needs to be 0.6 to 0.8.

Among the techniques for introducing oxygen-containing functional groups, into the petroleum pitch, there are, for example, a wet method by an aqueous solution of nitric acid, a mixed acid or hypochrorous acid, a dry method by an acidifying gas, such as oxygen, and a reaction by a solid reagent, such as sulfur, ammonia nitrate, ammonia persulfate or ferric chloride. Although there is no limitation to the oxygen content of the petroleum pitch, it is preferably not less than 3% and more preferably not less than 5%, as disclosed in the Japanese Laid-Open Patent Publication H3-252053. By controlling the oxygen content in this manner, the (002) spacing of the ultimately produced carbonaceous material is not less than 0.37 nm, while no peak of heat evolution is exhibited in the DTA in air at 700° C. or higher, thus increasing the capacity.

The compound mainly composed of phosphorus, oxygen and carbon, as disclosed in the Japanese Patent Application 2001-197596, also exhibits physical parameters similar to those of the non-graphitizable carbon, and may be used as an anode active material.

Moreover, any other organic materials that prove non-graphitizable carbon through the process of solid-phase carbonization by e.g. oxygen cross-linking processing may be used as a starting material. It is noted that there is no limitation to a processing method for achieving oxygen cross-linking.

For producing the non-graphitizable carbon, the aforementioned organic material is carbonized at 300 to 700° C. and sintered, at a temperature raising rate of 1 to 100° C. per minute, at an ultimate reached temperature of 900 to 1300° C. and for the holding time at the ultimate reached temperature of 0 to 30 hours. The carbonizing operation may also be omitted, if so desired.

The non-graphitizable carbon, obtained as described above, proves an anode active material through the processes of comminution and classification. This comminution may be carried out at any time of during carbonization, calcination, in a pre-or post-stage of high temperature heat processing, or during the temperature raising process.

Among the carbonaceous materials, the graphite may be exemplified by natural graphite and artificial graphite which is processed at an elevated temperature following carbonization of an organic material.

The artificial graphite is produced from an organic material, such as coal or pitch, as a starting material. The pitch may be coal tar, ethylene bottom oil or tars obtained on high temperature thermal cracking of crude oil, products obtained from asphalt by distillation, such as vacuum distillation, atmospheric distillation or steam distillation, thermal polycondensation, extraction or chemical polycondensation, or the pitch generated on dry distillation of wood. The starting materials for pitch may be enumerated by polyvinyl chloride resin, polyvinyl acetate, polyvinyl butyrate, and 3,5-dimethylphenol resins.

Other examples of the starting materials for the pitch include condensed polycyclic hydrocarbon compounds, such as naphthalene, phenanthrene, anthracene, triphenylene, pyrene, perylene, pentaphene, or penracene, and other derivatives, such as carboxylic acids thereof, carboxylic acid anhydrides or carboxylic acid imides, or mixtures thereof, and condensed heterocyclic compounds, such as acenaphthylene, indole, isoindole, quinoline, isoquinoline, quinoxaline, phthaladine, carbazole, acrydine, phenadine or phenanthridne.

For producing artificial graphite, the aforementioned organic material is first carbonized at 300 to 700° C. and calcined, in an inert gas stream, at a temperature raising rate of 1 to 100° C. per minute, at an ultimate reached temperature of 900 to 1500° C. and for the holding time at the ultimate reached temperature of 0 to 30 hours. The product obtained up to this process is the graphitizable carbonaceous material. This material is then heat-treated at a temperature not lower than 2000° C. and preferably not lower than 2500° C. The carbonizing and/or calcining step may be omitted, if so desired.

The artificial graphite, thus obtained, is pulverized and classified to prove an anode active material. This pulverization may be by carbonization, calcination or by the temperature raising process. Ultimately, the heat treatment for graphization is carried out in a finely divided state of the artificial graphite.

The true density of graphite is preferably not less than 2.1 g/cm³ and more preferably not less than 2.18 g/cm³. For realizing this true density, it is necessary that the (002) spacing, as obtained by the X-ray diffraction method, is preferably less than 0.34 nm, and more preferably not less than 0.335 nm and not larger than 0.337 nm, and that the C-axis crystallite thickness on the (002) plane is not less than 14 nm.

For decreasing the deterioration in capacity with the increasing number of the battery cycles, and for elongating the useful cyclic life of the battery, the bulk density and the average value of the shape parameter x of the graphite material are crucial.

That is, the bulk density of the graphite as measured by the method described in JISK-1469 is preferably not less than 0.4 g/cm³, more preferably not less than 0.5 g/cm³ and most preferably not less than 0.6 g/cm³. With the anode 5, containing the graphite having the bulk density not less than 0.4 g/cm³, the anode material is not liable to be peeled off from the layer of the anode active material, thus assuring an optimum electrode structure. Consequently, the battery 1 having this anode 5 has an extended useful life.

For further extending the useful life, it is desirable to use the graphite which not only has the bulk density in the above range but also an average value of the shape parameter x of the general formula x=(W/T)·(L/T) of 125 or less.

The shape parameter x means a product of L/T and W/T, where T is a thickness of a thinnest portion of particulate graphite in the form of a flat column or a parallelepiped, L is the length along the long axis of the particulate graphite and W is the length thereof in a direction perpendicular to the long axis. It may be said that the smaller the shape parameter x of a graphite particle, the larger is the height with respect to the bottom surface area and the lower is the flatness of the graphite particle.

The anode 5 prepared using a graphite material having the bulk density in the above range and the average value of the shape parameter x not larger than 125 has an optimum electrode structure and a longer useful life. Meanwhile, the average value of the shape parameter x is more preferably not less than 2 and not larger than 115 and most preferably not less than 2 and not larger than 100.

On the other hand, in the grain size distribution of graphite, as found by the laser diffraction method, it is desirable that the cumulated 10% particle size, cumulated 50% particle size and the cumulated 90% particle size of graphite are not less than 3 μm, not less than 10 μm and not larger than 70 μm, respectively. In particular, if the 90% particle size of graphite is not larger than 60 μm, the initial defects may be suppressed appreciably.

By affording a certain allowance to the grain size distribution, it becomes possible to charge the graphite efficiently to the electrode. It is desirable that the grain size distribution of the graphite is closer to the Gaussian distribution. If the number of distribution of the particles with a smaller grain size is larger, the risk is higher that the heating temperature at the time of the emergency such as overcharging is higher. If conversely the number of distribution of the particles with a larger grain size is large, the risk is high that malfunctions such as voltage decrease is produced at the time of initial charging. The reason is that, when the graphite lithium ions are introduced into graphite layers forming the anode 5 as charging proceeds, the crystallites of the graphite are swollen by about 10%, so that the anode 5 is more likely to press the cathode 6 or the separator 7.

Thus, by employing graphite having a grain size distribution comprising a wide range of particle sizes from the coarse grains to fine grains, in a well-balanced fashion, such battery 1 having a higher operating efficiency may be produced.

The average value of the destruction strength of graphite particles is desirably not less than 6 kgf/mm². In general, with the graphite having high crystallinity, hexagonal lattice faces are developed along the a-axis direction, and c-axis crystallites are formed by the hexagonal lattice faces heaped together. However, the hexagonal lattices of carbon are bound together by the weak bonding proper to the Van der Waals force and hence are liable to be deformed by the force of stress. Thus, when graphite is compression-molded and packed into a battery, it is more susceptible to collapsing than the carbonaceous materials sintered at a lower temperature, such that it is difficult to procure voids. The non-aqueous liquid electrolyte 4 is held in the voids in the carbonaceous material, so that, the larger the number of the voids, the larger is the amount of the non-aqueous liquid electrolyte 4 and the better is the ion diffusion at the time of discharging.

In other words, with the average value of the destruction strength of graphite particles of not less than 6 kgf/mm², a sufficient number of voids may be procured in the graphite and a sufficient amount of the non-aqueous liquid electrolyte 4 may be accommodated. That is, with the battery 1 employing this type of graphite, ion diffusion at the anode 5 is optimized to improve load characteristics.

The anode active material is preferably a graphized molded product which is obtained by heat treating a molded product of the carbonaceous material and by pulverizing and classifying the so produced graphized molded product. This graphized molded product is higher in bulk density and in destruction strength than the above-mentioned graphite.

The graphized molded product is obtained by mixing coke as a filler and a binder pitch as a molding or sintering agent, carbonizing the resulting mixture by pitch immersion and graphizing the resulting product. It is possible to use a starting material of the filler, to which are imparted molding and sintering characteristics, in order to obtain a similar graphized molded product.

The graphized molded product is made up by the coke as the filler and the binder pitch, polycrystal pairs are produced following the graphization, while sulphur or nitrogen is contained in the feedstock and turned into a corresponding gas at the time of the heat treatment, thus producing micro-sized pores for the gas to pass to facilitate doping/undoping of lithium ions as the anode material. From the perspective of application to the industry, there is further an added merit that it is possible to raise the processing efficiency.

Among the carbonaceous materials, the graphitizable carbon is prepared from a starting material which is similar to that for the artificial graphite described above. In the course of carbonization, the coal or the pitch exists as a liquid at a maximum temperature of the order of 400° C. By maintaining this temperature, the aromatic rings are condensed together to form a polycyclic state to set up a laminated oriented condition. When the temperature is raised to 500° C. or higher, a solid carbon precursor, that is semi-coke, is formed. This process is typical of the process of forming graphitizable carbon, and is termed a liquid phase carbonizing process.

In the anode 5, e.g. metal oxides may be contained in the layer of the active material 10, in addition to the aforementioned metals, compounds and the carbonaceous materials. As the metal oxides, oxides containing transition metals, for example, crystalline compounds or amorphous compounds, mainly composed of iron oxide, ruthenium oxide, molybdenum oxide, tungsten oxide, titanium oxide, tin oxide or silicon oxide, may be used. In particular, the compounds having the charging/discharging potential close to that of metal lithium are desirably contained in the layer of the active material 10.

In the above-described anode 5, in which the layer of the active material 10 contains metals that may be alloyed with lithium, the battery 1 may be of a higher capacity than the conventional non-aqueous electrode battery having only the carbonaceous material as the anode active material.

Moreover, with the anode 5, since the layer of the active material 10, containing the metals that may be alloyed with lithium, is formed to a thickness on the order of several μm by a thin film forming technique, it is possible to suppress cracking of the anode active material, otherwise caused by expansion and contraction of the anode active material, ascribable to charging/discharging of the battery 1, as compared to the conventional case of using particulate lithium alloy as the anode active material.

Additionally, with the anode 5, the metals not alloyed with lithium and which are contained in addition to the anode active material, alloys or compounds containing these metals, or the carbonaceous materials are scarcely expanded or contracted by charging/discharging of the battery 1, and thus act as a cushioning material for the anode active material expanded or contracted by charging/discharging of the battery 1. Thus, with the present anode 5, the metals which are not alloyed with lithium, alloys or compounds containing these metals, or the carbonaceous materials are contained in the anode 5 in addition to the anode active material, to suppress the neighboring lithium alloy particles, expanded due to charging as conventionally, from being cracked by being thrust against one another, with the result that it is possible to suppress the cracking of the anode active material or the chipping of the layer of the active material 10 otherwise caused by repeated expansion and contraction of the anode active material caused in turn by repetitions of the charging/discharging of the battery 1.

In the anode 5, the thickness of the layer of the active material 10 is not larger than 20 μm, more preferably not larger than 10 μm and most preferably not larger than 5 μm. If the thickness of the layer of the active material 10 exceeds 20 μm, the effect of forming the anode active material as a thin film is weakened such that the layer of the active material 10 may be cracked and flaked off as a result of expansion and contraction of the anode active material ascribable to the charging/discharging of the battery 1. Thus, with the anode 5, the thickness of the layer of the active material 10 is set to 20 μm or less, such as to suppress the cracking of the anode active material or the chipping of the layer of the active material 10 caused by expansion and contraction of the anode active material caused in turn by the charging/discharging of the battery 1.

In the anode 5 shown in FIG. 1, the current collecting layer 9 and the layer of the active material 10 are sequentially layered on the anode substrate 8. This, however, is merely illustrative and does not limit the present invention. For example, the aforementioned operation and effect may be achieved by the structure in which there are formed plural layers of the active material 10.

The anode 5 is also not limited to the structure shown in FIG. 1. The aforementioned operation and effect of the anode 5 may be obtained if the anode is comprised of for example a layered structure of one or more of the current collecting layer 9, one or more of the layer of the active material 10, which is a thin film formed only of the anode active material, and one or more of the metal layer which is a thin film formed only of metals not alloyed with lithium. In this case, the aforementioned operation and effect of the anode 5 may be obtained in case a compound layer which is a thin film formed of a compound containing metals not alloyed with lithium or a carbon layer which is a thin film formed only of a carbonaceous material capable of doping/undoping lithium ions is substituted for the metal layer. The anode 5 may also be a composite material including one or more of a metal layer, a compound layer and a carbon layer, in addition to the current collecting layer 9 and the layer of the active material 10. When formed of an electrically conductive metal, such as Cu or Fe, the metal layer may also act as the current collecting layer 9.

The anode 5 is not limited to the structure shown in FIG. 1, because the operation and effect of the anode 5 described above may be obtained if the anode is of a layered structure comprised of one or more of the current collecting layer 9, one or more of the layer of the active material 10 and one or more of a mixture layer obtained on compacting metals not alloyed with lithium or the carbonaceous material with a binder. The anode 5 may also be a composite material including one or more of a metal layer, a compound layer, a carbon layer and a mixture layer, in addition to the current collecting layer 9 and the layer of the active material 10. As the binder used for the mixture layer, any suitable binder formed of a known resin material routinely used for this sort of the non-aqueous electrode battery may be used. Examples of these binders include polyvinylidene fluoride and styrene butadiene rubber.

In the cathode 6, a cathode mixture layer 13 containing a cathode active material is formed on a cathode collector 12. A cathode terminal 14 is connected to a predetermined location of the cathode collector 12 of the cathode 6 for protruding from one width-wise end of the cathode collector 12. As this cathode terminal 14, a strip-shaped metal piece of an electrically conductive metal, such as aluminum, is used.

As the cathode collector 12 of the cathode 6, a net- or foil-shaped aluminum piece is used. As the binder contained in the cathode mixture layer 13 of the cathode 6, any suitable known resin material, routinely used for this sort of the non-aqueous electrode battery, may be used. Specifically, polyvinylidene fluoride, for example, may be used as the binder. As the electrically conductive material, contained in the cathode mixture layer 13 of the cathode 6, any suitable known electrically conductive material, routinely used for this sort of the non-aqueous electrode battery, may be used. Specifically, carbon black or graphite, for example, may be used as the electrically conductive material.

In this cathode 6, the cathode active material contained in the cathode mixture layer 13 may, for example, be oxides, sulfides, nitrides, silicon compounds, lithium-containing compounds or complex metal compounds or alloys.

Specifically, in case the anode 5 has a sufficient amount of lithium, complex transition metal oxides, represented for example by the general formula MₓO_{y}, where M is one or more of transition metals, are used as the cathode active material. In case the anode 5 does not have a sufficient amount of lithium, lithium complex oxides, represented by the general formula LiMO₂, where M is a compound of one or more of Co, Ni, Mn, Fe, Al, V and Ti, for example, are used. The lithium complex oxides may be exemplified by, for example, LiCoO₂, LiNiO₂, LiₓNi_{y}Co_{1-y}O₂, where x, y differ depending on the charging/discharging states of the battery and usually 0<x<1 and 0.7<y<1.02, and spinel type lithium manganese complex oxides, represented by the general formula LiMn₂O₄.

In the battery element 2, the separator 7, used for separating and the anode 5 cathode 6 from each other, may be formed of any suitable known material routinely used as an insulating porous film for this sort of the non-aqueous electrode battery. Specifically, polymer films of, for example, polypropylene or polyethylene, may be used. From the relationship between the lithium ion conductivity and the energy density, the thickness of the separator 7 is desirably as thin as possible, with the thickness being not larger than 30 μm.

The outer can 3 is in the form of a bottomed tubular vessel, with its bottom being e.g. circular. Though the outer can 3 is in the form of bottomed tubular vessel, as shown in FIG. 1, it is not limited to this shape and may, for example, be a bottomed tubular vessel having a rectangular or flat circular bottom surface. In case the outer can 3 is electrically connected to the anode 5, the outer can is formed of an electrically conductive metal, such as iron, stainless steel or nickel. In case the outer can 3 is formed of e.g. iron, its surface is plated e.g. with nickel.

The non-aqueous liquid electrolyte 4 is a non-aqueous solution in which an electrolyte salt is dissolved in a non-aqueous solvent. In the non-aqueous liquid electrolyte 4, it is presupposed that a high dielectric constant solvent with a high ability of dissolving an electrolyte salt is used as a main solvent. It is however also possible to use a mixed solvent comprised of the high dielectric constant solvent added by a low viscosity solvent having a high transporting ability for electrolyte ions.

The high dielectric constant solvent may be exemplified by propylene carbonate (PC), ethylene carbonate (EC), butylene carbonate (BC), vinylene carbonate (VC), sulforanes, butyrolactones and valerolactones. The low viscosity solvent may be exemplified by symmetrical or non-symmetrical chained carbonates, such as diethyl carbonate, dimethyl carbonate (DMC), methylethyl carbonate or methylpropyl carbonate. These non-aqueous solvents may be used either singly or in combination of two or more.

Meanwhile, if PC as a main solvent of the non-aqueous solvents and graphites as the anode active material are used in combination, PC tends to be decomposed by the graphites, thus possibly decreasing the battery capacity. For this reason, when graphites are used as the anode active material, EC not liable to be decomposed by graphites or a compound obtained by substituting a halogen element for the hydrogen atom of EC is used as the main component of the non-aqueous solvent.

In this case, optimum battery characteristics may be obtained by substituting a second solvent component for a portion of EC not liable to be decomposed by graphites or a portion of the compound obtained by substituting a halogen element for the hydrogen atom of EC. The second solvent component may be enumerated by PC, BC, VC, 1,2-dimethoxyethane, 1,2-diethoxyethane, γ-butyrolactone, valerolactone, tetrahydrofuran, 2-methyl tetrahydrofuran, 1,3-dioxolane, 4-methyl-1,3-dioxolane, sulforane, and methyl sulforane. In particular, carbonate based solvents, such as PC, BC or VC, are desirable. The amount of addition of the second solvent component is desirably less than 10 vol %.

In the non-aqueous liquid electrolyte 4, there is no limitation to the electrolyte salt if the electrolyte salt is a lithium salt exhibiting ion conductivity. The non-aqueous liquid electrolyte 4 may be enumerated by, for example, LiClO₄, LiAsF₆, LiPF₆, LiBF₄, LiB(C₆H₅)₄, CH₃SO₃L₁, CF₃SO₃Li, LiN(CF₃SO₂)₂, LiC(CF₃SO₂)₃, LiCl and LiBr. These may be used singly or in combination.

The battery 1 of the above-described structure may be manufactured as follows: First, the current collecting layer 9 in the anode 5 is prepared. If, in producing the current collecting layer 9, the anode substrate 8 is a polymer film, the current collecting layer 9 is prepared by forming a film of the electrically conductive metal on the major surface of the anode substrate 8 by the thin film forming technique. When the anode substrate 8 is a metal foil, the anode substrate 8 may perform the role of the current collecting layer 9, because the anode substrate 8 is electrically conductive.

The layer of the active material 10 in the anode 5 then is formed. The layer of the active material 10 is prepared by forming a film of the anode active material on the current collecting layer 9 by the thin film forming technique. If the anode substrate 8 is a metal foil, the surface of the anode substrate 8 is defatted with a rinse solution of for example alcohol and subjected to an activating treatment with e.g. an aqueous solution of phosphoric acid or an aqueous solution of dilute sulfuric acid. The layer of the active material 10 then is formed on the so processed anode substrate 8.

The current collecting layer 9 and the layer of the active material 10, formed as described above, are cut to a predetermined size, along with the anode substrate 8, and the anode terminal 11 is mounted at a predetermined location of the anode substrate 8. This completes the elongated anode 5.

The cathode 6 then is prepared. In preparing the cathode 6, a coating liquid of the cathode mixture, containing the aforementioned cathode active material, electrically conductive material and the binder is prepared. This coating liquid of the cathode mixture is applied uniformly on the major surface of the cathode collector 12, dried and then compacted to form the cathode mixture layer 13. The resulting product is cut to a predetermined size and the cathode terminal 14 is mounted in position by for example ultrasonic welding. This completes the elongated cathode 6.

The anode 5 and the cathode 6 are layered together, with the elongated separator 7 in-between, and coiled together a large number of turns to complete the battery element 2. At this time, the battery element 2 is of such a coiled structure in which the anode terminal 11 and the cathode terminal 14 are protruded from one end face and the opposite end face along the width-wise direction of the separator 7, respectively.

A pair of insulating plates 15a, 15b are mounted on both end faces of the battery element 2 and the battery element 2 is then housed in the outer can 3. For collecting the current of the anode 5, the portion of anode terminal 11 protruded from the battery element 2 is welded to e.g. the bottom of the outer can 3. The outer can 3 is electrically connected in this manner to the anode 5 and proves an outer anode of the battery 1. For collecting the current of the cathode 6, the portion of cathode terminal 14 protruded from the battery element 2 is welded to a thin sheet for current interruption 16 for electrically connecting the cathode terminal to the battery cover 17 with interposition of the thin sheet for current interruption 16. This thin sheet for current interruption 16 operates for interrupting the current depending on the internal pressure in the battery. The battery cover 17 is electrically connected to the cathode 6 in this manner to serve as an outer cathode for the battery 1.

The non-aqueous liquid electrolyte 4 then is injected into the outer can 3 in which is accommodated the battery element 2. This non-aqueous liquid electrolyte 4 is prepared by dissolving the aforementioned electrolyte salt in the aforementioned non-aqueous solvent. The opening end of the outer can 3 is caulked with an asphalt-coated gasket 18 to secure the battery cover 17 to complete the battery 1.

The battery 1 is also provided with an adhesive tape 19 for preventing the wound state of the battery element 2 from becoming loose, and with a safety valve 20 for degassing the internal space of the battery when the pressure therein exceeds a preset value.

With the battery 1, manufactured in this manner, since the layer of the active material 10 in the anode 5 contains metals that can be alloyed with lithium, the capacity of the battery 1 is higher than that of the conventional non-aqueous electrode battery in which only the carbonaceous material is used as the anode active material.

Moreover, with the present battery 1, in which the layer of the active material 10 of the anode 5, containing e.g. the anode active material, is formed as a film of a thin thickness of the order of several μm, the cracking of the anode active material otherwise produced by expansion and contraction of the anode active material caused by charging/discharging may be suppressed as compared to the conventional battery in which particulate lithium alloys, for example, are used as the anode active material. Thus, with the present battery 1, it is possible to prevent battery characteristics from being lowered by deterioration of the anode caused in turn by the cracking of the anode active material attendant on the repetition of charging/discharging and resultant deterioration of battery characteristics as occurred in the conventional battery.

Additionally, with the battery 1, the metals not alloyed with lithium, alloys or compounds containing these metals and the carbonaceous material, contained in the layer of the active material 10 of the anode 5 in addition to the anode active material, are scarcely expanded or contracted by charging/discharging, and thus act as a cushioning material for the anode active material expanded or contracted by charging/discharging of the battery 1. Thus, with the present battery 1, since the metals not alloyed with lithium, alloys or compounds containing these metals, carbonaceous materials, contained in the battery in addition to the anode active material, suppress the neighboring lithium alloy particles, expanded due to charging, from being thrust against one another and thereby cracked, as occurred conventionally, it is possible to suppress the cracking of the anode active material or the chipping of the layer of the active material 10, otherwise brought about by repeated expansion and contraction of the anode active material, caused in turn by repetitions of the charging/discharging. Thus, with the present battery 1, battery characteristics can be prevented from being lowered due to cracking of the anode active material or chipping of the layer of the active material 10.

Moreover, by employing a polymer film with a light true specific gravity, as the anode substrate 8, the battery 1 may be made lightweight, thus increasing the energy density. Additionally, by employing a polymer film with a large tensile strength, as the anode substrate 8, it is possible to prevent breakage or severance of the anode substrate, as occurred in manufacturing the conventional battery, thus improving the manufacturing yield.

In the above embodiment, the battery 1 uses the non-aqueous liquid electrolyte 4. This is merely illustrative and does not limit the present invention. That is, the present invention may be applied to such a case where an inorganic solid electrolyte, a high polymeric solid electrolyte or a gel electrolyte is used in lieu of the non-aqueous liquid electrolyte 4. The inorganic solid electrolyte may be exemplified by lithium nitride and lithium iodide.

The high polymeric solid electrolyte is formed by the aforementioned electrolyte salt and a high polymeric compound, to which ion conductivity is imparted by the electrolyte salt contained therein. The high polymeric compound, used for the high polymeric solid electrolyte, may be enumerated by, for example, silicon, polyether modified siloxane, polyacryl, polyacrylonitrile, polyphosphasen polyethylene oxide, polypropylene oxide, and complex polymers, cross-linked polymers or modified polymers thereof, an acrylonitrile butadiene rubber, a polyacrylonitrile-butadiene styrene rubber, an acrylonitrile-polyethylene chloride-propylene-diene-styrene resin, an acrylonitrile-vinyl chloride resin, an acrylonitrile-methacrylate resin, an acrylonitrile-acrylate resin, and an etheric high polymeric material, such as cross-linked product of polyethylene oxide. These may be used either singly or in combination.

Other examples of the high polymeric compound, used in the high polymeric solid electrolyte, include copolymers of acrylonitrile with one or more of vinyl acetate, methyl methacrylate, butyl methacrylate, methyl acrylate, butyl acrylate, itaconic acid, methyl acrylate hydroxide, ethyl acrylate hydroxide, acrylamide, vinyl chloride and vinylidene fluoride, and fluorine-based polymers, such as poly(vinylidene fluoride), poly(vinylidene fluoride-co-hexafluoropropylene, poly(vinylidene fluoride-co-tetrafluoroethylene), and poly(vinylidene fluoride-co-trifluoroethylene). These may be used either singly or in combination.

The gel electrolyte is formed by the aforementioned non-aqueous liquid electrolyte 4 and a polymeric matrix material which is gelated on absorption of the non-aqueous liquid electrolyte 4. As the polymeric matrix material, used for the gel electrolyte, any of the above-mentioned high polymeric compounds that may be geleated on absorbing the non-aqueous liquid electrolyte 4 may be used. Specifically, the polymeric matrix material may be enumerated by fluorine-based polymeric materials, such as poly(vinylidene fluoride) or poly(vinylidene fluoride-co-hexafluoro propylene), etheric polymer material, such as poly(ethylene oxide) or a cross-linked product thereof, and poly(acrylonitrile). These may be used either singly or in combination. In particular, fluorine-based polymeric materials, exhibiting superior redox stability, are preferentially used as the polymeric matrix material.

The foregoing description has been made by taking the cylindrically-shaped battery 1 as an example for illustration. This invention is, however, not limited to this example and may also be applied to a variety of sizes and shapes of batteries, such as batteries employing a metal vessel as an exterior material, e.g. a coin-shaped, square-shaped or a button-shaped battery, a thin type battery or a battery employing a laminate film as an exterior material.

### EXAMPLES OF THE INVENTION

In the following, several samples of lithium ion secondary batteries, actually produced as non-aqueous electrode batteries, embodying the present invention, are explained.

<Sample 1>

In the sample 1, an anode was first produced. In producing the anode, Cu was deposited to a thickness of 2 μm on the major surface of an anode substrate formed by a polyester film, 5 μm in thickness, as a current collecting layer, and Sn was formed by vapor deposition on this current collecting layer, to a thickness of 3 μm, as a layer of an active material. The current collecting layer and the layer of the active material, sequentially formed on the anode substrate, were cut to a predetermined size, along with the anode substrate, and the resulting product was mounted on the anode substrate so that an anode terminal of nickel will be electrically contacted with the current collecting layer. This completed the elongated anode.

The cathode active material was then prepared. For producing the cathode active material, a mixture obtained on mixing lithium carbonate and cobalt carbonate, as starting materials, at a ratio of 0.5 mol to 1 mol, was sintered in air at 900° C., for about five hours, and the resulting sintered product was pulverized to particulate LiCO₂. It was confirmed that a peak of the so produced LiCO₂ is coincident with that of LiCoO₂ registered in the JCPDS file.

A cathode then was prepared. For preparing the cathode, 91 parts by weight of a mixture obtained on mixing 95 parts by weight of LiCoO₂, obtained as described above, and 5 parts by weight of lithium carbonate, 6 parts by weight of graphite, as an electrically conductive material, 3 parts by weight of polyvinylidene fluoride (PVdF), as a binder, and N-methyl-2-pyrrolidone (NMP), as a solvent, were added together and kneaded by a planetary mixer for dispersion, in order to produce a coating liquid of the cathode mixture. Using a die coater, as a coating apparatus, the coating liquid was uniformly applied to the major surface of a band-shaped aluminum foil, as a cathode collector, 20 μm in thickness. The resulting product was dried for 24 hours at 100° C. in vacuo and compression-molded by a roll press, and the resulting product was cut to a predetermined size, in order to have a cathode terminal of aluminum mounted on the cathode collector. This completed an elongated cathode.

Then, for preparing the battery element, the anode and the cathode, thus produced, were layered together, with interposition of a separator of a porous polyethylene film, 23 μm in thickness, to form a layered product. This layered product was coiled a number of turns along the longitudinal direction of the layered product. This completed a battery element having an outer diameter of 14 mm. At this time, an anode terminal and a cathode terminal were drawn out from one and the opposite end faces of the so produced battery element, respectively.

Then the anode terminal, taken out from the battery element produced, was welded to the nickel plated iron outer can, while the cathode terminal was welded to the battery cover, and the battery element was accommodated in the outer can.

The non-aqueous liquid electrolyte, obtained on dissolving LiPF₆ in a mixed solvent of ethylene carbonate and dimethyl carbonate at a volumetric ratio of 1:1, so that the molar ratio of LiPF₆ to the mixed solvent is 1 mol/lit, was prepared. This non-aqueous liquid electrolyte was then charged into the outer can and the battery cover was press-fitted to the opening end of the outer can with interposition of an asphalt-coated gasket to caulk the opening part of the outer can to secure the battery cover in position.

In this manner, a cylindrically-shaped lithium ion secondary battery, with a diameter of 15 mm and a height of 50 mm, was manufactured. It is noted that, in the following description, the lithium ion secondary battery is referred to simply as the battery.

<Sample 2>

In the sample 2, an anode was prepared as in the sample 1, and was heated at 150° C. for 24 hours in vacuo to form an intermetallic compound of Cu—Zn. The battery was prepared in the same way as the sample 1, except that this anode was used in this sample 2.

<Sample 3>

In the sample 3, an anode was prepared as follows: In preparing the anode of the sample 3, Cu was formed by vapor deposition to a thickness of 2 μm on the major surface of the anode substrate of the polyester film, 3 μm thick, to form a current collecting layer. On this cur-rent collecting layer, Sn was formed by vapor deposition to a thickness of 3 μm, as a layer of the active material. On this layer of the active material, Cu was formed by vapor deposition to a thickness of 2 μm, as a metal layer. The current collecting layer, layer of the active material and the metal layer, sequentially formed on the anode substrate, were cut to a predetermined size, along with the anode substrate. An anode terminal of nickel was mounted on the anode substrate so that the anode terminal is electrically connected to the current collecting layer, to complete the anode.

This anode was heated at 150° C. in vacuo for 24 hours to form an intermetallic compound of Cu-Zn. A battery was prepared in the same way as in sample 1 except that this anode was used in this sample 3.

<Sample 4>

In the sample 4, an anode was prepared as follows: In preparing the anode of the sample 4, Al was formed by vapor deposition to a thickness of 2 μm, on the major surface of the anode substrate of the polyester film, 3 μm in thickness, to form a current collecting layer. On this current collecting layer, Cu was formed by vapor deposition, as a metal layer, to a thickness of 2 μm. On this metal layer, Sn was formed by vapor deposition, as a layer of the active material, to a thickness of 3 μm. The current collecting layer, layer of the active material and the metal layer, sequentially formed on the anode substrate, were cut to a predetermined size, along with the anode substrate. An anode terminal of nickel was mounted on the anode substrate so that the anode terminal is electrically connected to the metal layer, to complete the anode.

This anode was heated at 150° C. in vacuo for 24 hours to form an intermetallic compound of Cu—Zn. A battery was manufactured in the same way as in sample 1 except that this anode was used in this sample 4.

<Sample 5>

In the sample 5, an anode was prepared as follows: In preparing the anode of the sample 5, Cu was deposited to a thickness of 1 μm on the major surface of the anode substrate formed by a polyester film, 3 μm in thickness, to form a current collecting layer. On this current collecting layer, Cr was deposited, as a first metal layer, to a thickness of 1 μm and, on this first metal layer, Cu was deposited to a thickness of 1 μm, as a second metal layer. On this second metal layer, Sn was deposited to a thickness of 3 μm, as a layer of the active material. On this layer of the active material, Cu was formed by vapor deposition to a thickness of 2 μm, as a third metal layer. The current collecting layer, plural metal layers and the layer of the active material, sequentially formed on the anode substrate, were cut to a predetermined size, along with the anode substrate. An anode terminal of nickel was mounted on the anode substrate so that the anode terminal is electrically connected to the first metal layer, to complete the anode.

This anode was heated at 150° C. in vacuo for 24 hours to form an intermetallic compound of Cu—Zn. A battery was manufactured in the same way as in sample 1 except that this anode was used in this sample 5.

<Sample 6>

In the sample 6, an anode was prepared as follows: In preparing the anode of the sample 6, Cu was deposited to a thickness of 1 μm on the major surface of the anode substrate formed by a polyester film, 3 μm in thickness, to form a current collecting layer. On this current collecting layer, Cr was deposited, as a first metal layer, to a thickness of 1 μm and, on this first metal layer, Cu was deposited to a thickness of 1 μm, as a second metal layer. On this second metal layer, Sn was deposited to a thickness of 3 μm, as a layer of the active material. On this layer of the active material, Cu was deposited to a thickness of 2 μm, as a third metal layer. The resulting product was heated at 150° C. in vacuo for 24 hours to form an intermetallic compound of Cu—Zn.

A coating liquid of an anode mixture, comprised of a homogeneous dispersion in NMP of 90 parts by weight of graphite powders and 10 parts by weight of PVdF as a binder was homogeneously coated on the third metal layer and dried in situ. The resulting dried product was compressed by a roll press to a mixture layer 30 μm in thickness. The current collecting layer, plural metal layers, the layer of the active material and the mixture layer, formed on the anode substrate, were cut to a predetermined size, along with the anode substrate. An anode terminal of nickel was mounted on the anode substrate so that the anode terminal of nickel is electrically connected to the metal layer, to complete the anode. A battery was produced in the same way as in the sample 1 except that this anode was used in this sample 6.

<Sample 7>

In the sample 7, an anode was prepared as follows: In producing the anode of the sample 7, 90 parts by weight of graphite powders, as an anode active material, and 10 parts by weight of PVdF, as a binder, were homogeneously dispersed in NMP to form a coating liquid of an anode mixture, which was then uniformly coated on the major surface of the anode substrate of a copper foil 15 μm in thickness, and dried in situ. The resulting dried product was compressed by a roll press to form a mixture layer 30 μm in thickness. The mixture layer, formed on the anode substrate, was cut to a predetermined size, along with the anode substrate. An anode terminal of nickel was mounted on the anode substrate to complete the anode. A battery was produced in the same way as in the sample 1 except that this anode was used in this sample 7.

<Sample 8>

In the sample 8, an anode was prepared in the same way as in the sample 1, except that the current collecting layer was not formed, that is, only the layer of the active material of Sn was formed on the major surface of the anode substrate of the polyester film. A battery was produced in the same way as in the sample 1 except that this anode was used in this sample 8.

Of the batteries of the samples 1 to 8, prepared as described above, measurements were made of the initial discharging capacity and the useful cyclic life.

The results of evaluation of the initial discharging capacity and the useful cyclic life in these respective samples are shown in Table 1.

TABLE 1

| | initial discharging | cyclic life (number of |
|---|---|---|
| | capacity (mAh) | cycles) |
| sample 1 | 712 | 106 |
| sample 2 | 725 | 153 |
| sample 3 | 726 | 234 |
| sample 4 | 727 | 249 |
| sample 5 | 727 | 265 |
| sample 6 | 656 | 289 |
| sample 7 | 580 | 300 |
| sample 8 | 732 | 18 |

In the respective samples, the initial discharging capacity was measured as follows: In measuring the values of the initial discharging capacity of the samples, constant current constant voltage charging of 0.3A and 4.2 V at the maximum was carried out for 6 hours for the respective battery samples. The constant current discharging, with the current value of 3A and up to the voltage of 2.5 V, was then carried out to measure the initial discharging capacity.

In the respective samples, the cyclic life was measured as follows: In measuring the cyclic life of the respective samples, a charging/discharging cycle, under the same conditions as those for the initial charging/discharging, was repeatedly carried out and the number of the cycles when the ratio of the discharging capacity to the initial discharging capacity was equal to 50% was adopted as the cyclic life.

Form the results of evaluation, shown in Table 1, it is seen that, with the samples 1 to 6, in which Sn that may be alloyed with lithium to enable the capacity to be increased is used as the anode active material, the initial discharging capacity is appreciably higher than that of the sample 7 in which graphite is used as the anode active material.

With the sample 7, in which an anode uses only the carbonaceous material as the anode active material, as conventionally, the capacity cannot be increased beyond a certain limit value, such that it is difficult to increase the battery capacity.

Conversely, with the samples 1 to 6, in which Sn that can be alloyed with lithium is used as the anode active material, such that the battery capacity can be increased appreciably as compared to that in case of using the carbonaceous material, the initial discharging capacity can be higher than with the sample 7.

From the results of evaluation, shown in Table 1, it may be seen that, with the samples 1 to 6, the anodes of which are compounded from metal layers of Cu or Cr or the graphite-containing mixture layers, as well as the layers of the active material, the cyclic life is appreciably longer than with the sample 8, the anode of which includes only the layer of the active material.

In the sample 8, in which the anode is formed solely by the thin layer of the active material of Sn, expansion and contraction of Sn attendant on repetition of charging/discharging may be lower than in case of using the particulate Sn, as conventionally, but cannot be suppressed to a sufficient extent. Thus, with the sample 8, the layer of the active material is cracked by repetition of expansion and contraction by 18 charging/discharging cycles, thus deteriorating the anode to lower battery characteristics.

Conversely, with the samples 1 to 6, the anode is compounded from the current collecting layer, metal layer(s) and the mixture layer, as well as the layer of the active material formed by a thin Sn film. Thus, with the samples 1 to 6, not only the layer of the active material can be prevented from becoming chipped as a result of using a thin Sn film and consequent suppression of expansion or contraction, but also the layer of the active material can be prevented from becoming chipped by the fact that the current collecting layer, metal layer and the mixture layer are scarcely subjected to expansion and contraction at the time of charging/discharging operating and thus act as a cushioning material against the expansion and contraction of Sn. Consequently, with the samples 1 to 6, the rate of growth of chipping in the layer of the active material, that is the rate of deterioration of the anode, may be retarded, with the result that the cyclic life is longer than with the sample 8.

It is seen from above that a battery in which both the need for the initial discharge capacity and the need for the cyclic life are met can be prepared by employing a thin film of Sn as the anode active material and by layering the layer of the active material of the anode with the metal layer and/or the mixture layer to provide a composite structure.

What is claimed is:

1. A non-aqueous electrode battery comprising
a cathode containing an cathode active material;
an anode including, as an anode active material, one or more thin film layer(s) containing a first metal that may be alloyed with lithium, said thin film layer(s) being formed by a thin film forming technique, said anode containing one or more of a second metal not alloyed with lithium, a third metal that may be alloyed with said second metal, a fourth metal not alloyed with said second metal, and a carbonaceous material capable of doping/undoping lithium ions; and
a non-aqueous electrolyte containing an electrolyte salt.

2. The non-aqueous electrode battery according to claim 1, wherein said first metal is an alloy composed of one or more of Mg, B, Al, Ga, In, Si, Ge, Sn, Pb, Sb, Bi, Cd, Ag, Zn, Hf, Zr and Y.

3. The non-aqueous electrode battery according to claim 1, wherein one or more of said second metal, third metal, fourth metal and said carbonaceous material is contained in said thin film layer of said anode.

4. The non-aqueous electrode battery according to claim 1, wherein one or more of a second thin film layer(s) containing one or more of said second metal, third metal, fourth metal and said carbonaceous material is provided by film forming by a thin film forming technique in said anode in addition to said thin film layer(s).

5. The non-aqueous electrode battery according to claim 1, wherein one or more of a mixture layer(s) containing one or more of said second metal, third metal, fourth metal and said carbonaceous material and a binder is provided in said anode in addition to said thin film layer(s).

6. The non-aqueous electrode battery according to claim 1, wherein the anode substrate of said anode is metal and/or a polymer.

7. The non-aqueous electrode battery according to claim 5, wherein said polymer is a high molecular weight polymer comprising one or more of an olefinic resin, a sulfur-containing resin, a nitrogen-containing resin and a fluorine-containing resin.

8. The non-aqueous electrode battery according to claim 5, wherein said polymer has a true specific gravity not less than 0.9 g/cc and not larger than 1.8 g/cc.

9. The non-aqueous electrode battery according to claim 1, wherein said cathode active material of said cathode is a lithium metal oxide represented by the general formula LiₓM_{y}O_{z}, where M is one or more of Co, Ni, Mn, Fe, Al, V or Ti, with x 1, y 1 and z 2.

10. The non-aqueous electrode battery according to claim 1, wherein said cathode in a band shape and said anode in a band shape are coiled along the longitudinal direction with a band-shaped separator in-between.
